(19) United States
(12) Patent Application Publication
(10) Pub. No.: US 2003/0111929 A1
(43) Pub. Date: Jun. 19, 2003

(54) Metal brush box with heat sink fins for decreasing brush temperature in an electric motor or alternator

(75) Inventors: Tao Hong, Farmington Hills, MI (US); John R. Savage, Rochester Hills, MI (US)

Correspondence Address: MATTHEW R. JENKINS, ESQ., 2310 FAR HILLS BUILDING, DAYTON, OH, 45419, US

(73) Assignee: Valeo Electrical Systems, Inc.

(21) Appl. No.: 10/017,667

(22) Filed: Dec. 13, 2001

(51) Int. Cl. H02K 9/00; H02K 13/00

(52) U.S. Cl. 310/239; 310/64

(57) ABSTRACT

A system and method for reducing brush temperature associated with an electric motor or alternator is disclosed as having at least one brush box for housing at least one brush biased radially toward an opening toward the commutator. The brush boxes have at least one or a plurality of heat sink fins associated therewith for thermally conducting heat away from the brushes.

### BACKGROUND OF THE INVENTION

1. Field of the Invention

The present invention relates to motors or alternators and, more particularly, to a direct current motor or alternator including a brush holder plate having a plurality of brush boxes for holding brushes and which have at least one or a plurality of heat sink fins associated with the brush boxes.

2. Description of Related Art

As is well known, an electric motor or alternator includes a rotor and a stator. The rotor generally includes an armature with windings, as well as a shaft extending from the armature and a commutator. The stator, which has magnets or coils therein, generally surrounds the rotor in the form of a yoke or cylindrical frame. Brushes are also provided and supported from the stator by a brush holder plate. By maintaining contact between the brushes and the commutator, current is transferred to the armature, which inspires an electromagnetic field. The interaction between the electromagnetic field of the armature and that of the stator causes rotation of the rotor to, thereby, perform work in a motor; this interaction also generates electricity in an alternator when the rotor is turned by external force.

In order to maintain the brushes in firm contact with the commutator, they have generally been positioned in a brush box situated on the brush holder plate and, typically, positively biased toward the center thereof by springs or the like. A recurrent problem with such motors and alternators has been the heat generated by the brushes increases the brush temperature, which increases the brush wear rate, which reduces the brush life and, thereby, the life of motor or alternator.

It is, therefore, an object of the invention to provide a brush box which can facilitate reducing the temperature of the brushes and, thereby improve the life of the motor or alternator.

### SUMMARY OF THE INVENTION

It is, therefore, a primary object of the invention to provide an electric motor or alternator having means for reducing the temperature of the brushes.

Another object of the invention is to provide a brush box having a heat sink in the form of at least one or a plurality of heat sink fins associated therewith in order to facilitate reducing the temperature of the brushes.

Still another object of the invention is to provide a heat sink in the form of a plurality of heat sink fins shaped and arranged in a way which reduces air flow resistance of heat sink fins and obtains high heat transfer coefficient.

In one aspect, this invention comprises an electric motor or alternator comprising a stator comprising a pair of magnets or coils for providing an electrical field, a rotor mounted on an armature shaft and rotatably positioned in the stator, the rotor comprising a commutator positioned on an armature shaft, a brush holder plate positioned around the commutator and comprising a plurality of brush boxes each capable of receiving at least one brush, and the brush box comprising a heat sink for dissipating heat generated by the brushes to lower a brush temperature.

In another aspect, this invention comprises a method for decreasing brush temperature of an electric motor or alternator comprising the steps of providing a motor or alternator having a housing comprising a stator comprising at least two magnets or coils for providing an electromagnetic field, providing a rotor mounted on an armature shaft, the rotor comprising a commutator positioned on an armature shaft, providing a brush holder plate having a plurality of brush boxes each capable of receiving at least one brush, and providing a heat sink on the brush box for dissipating heat generated by the brush.

In still another aspect, this invention comprises a brush holder plate having an aperture therethrough for receiving a commutator, the brush holder plate further comprising a plurality of brush boxes each having at least one brush therein for contacting the commutator when the commutator is positioned in the aperture, and the brush box comprising a heat sink.

Other objects and advantages of the inventions will be apparent from the following description, the accompanying drawings, and the appended claims.

### BRIEF DESCRIPTION OF THE DRAWINGS

FIG. 1 is an exploded perspective view of a DC motor including a brush holder plate having two brush boxes with heat sink fins in accordance with one embodiment of the invention;

FIG. 2 is a front view of the brush holder plate of the present invention;

FIG. 3 is a cross-sectional view of the brush holder plate of FIG. 2, taken along line A-A, where two brush boxes are shown having three heat sink fins each to facilitate reducing brush temperature;

FIG. 4 is a rear view of the brush holder plate shown in FIG. 2; and

FIG. 5 is a view of a predicted air velocity field around brush holder plate showing the heat sink fins are arranged generally along the predicted streamlines of the air flow around the brush holder plate.

### DETAILED DESCRIPTION OF THE PREFERRED EMBODIMENT

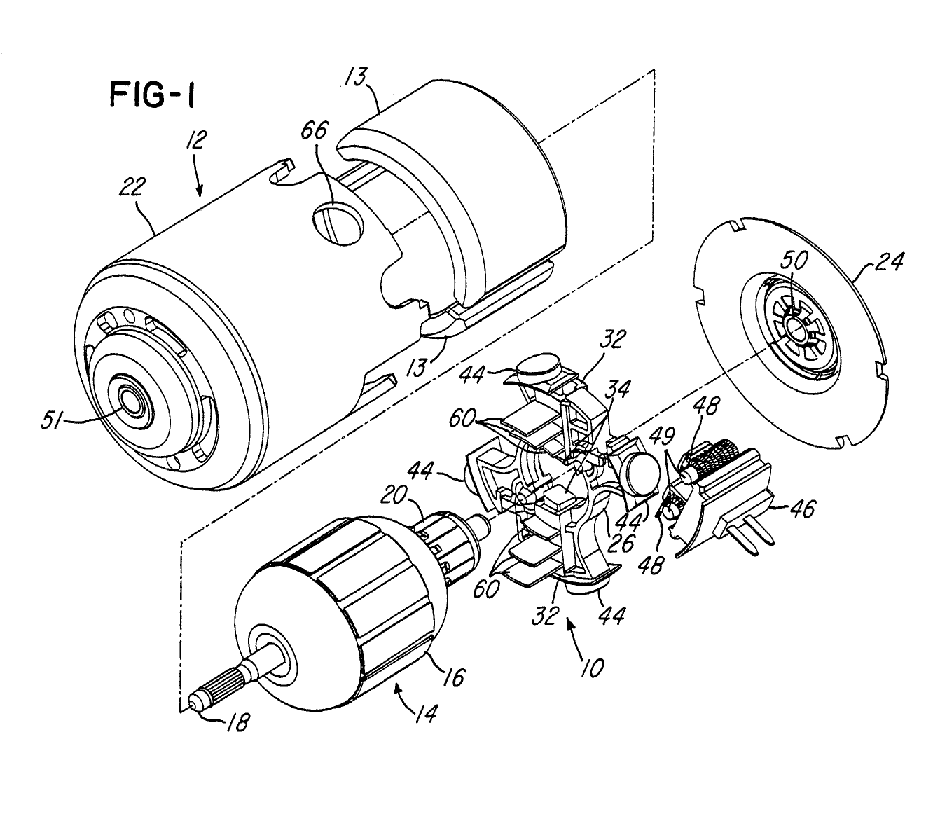

Referring now to FIG. 1, an electric motor 10 in accordance with one embodiment of the invention is shown. In the embodiment being described, the electric motor 10 is a direct-current (DC) motor comprising a stator 12 and a rotor 14. The rotor 14 includes an armature 16, an armature shaft 18 which extends through armature 16 and a commutator 20 positioned on armature shaft 18 adjacent to armature 16. The stator 12, as best illustrated in FIG. 1, has a housing 22 containing magnets 13 therein and an end cap 24 to which the housing 22 is connected. It will be understood that when DC motor 10 is assembled, rotor 14 will be surrounded by stator 12.

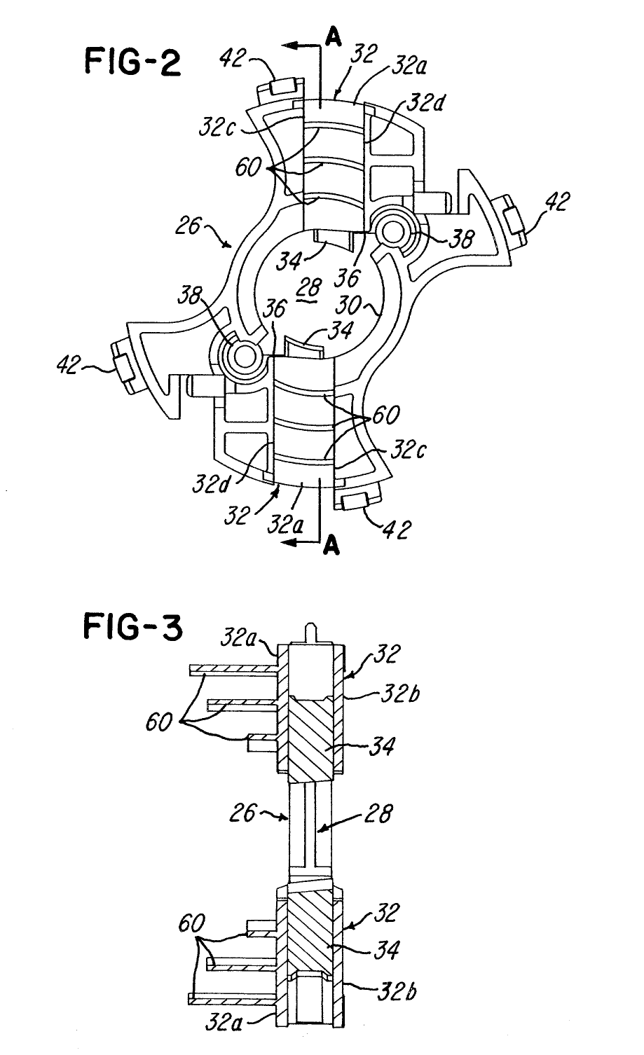

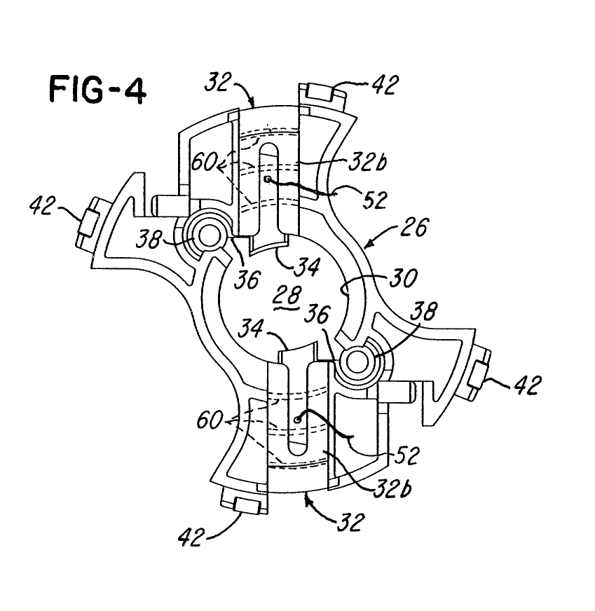

A brush holder plate 26 is provided which is positioned within housing 22 of stator 12. It should be appreciated that brush holder plate 26 has a central opening 28 therethrough defined by an annular wall 30 (as illustrated in FIGS. 2 and 4). At least one, and preferably two or more brush boxes 32 are provided on brush holder plate 26 for housing brushes 34, which are biased radially inward towards central opening 28. As is known in the art, brushes 34 may be biased by spring members 36, which are preferably attached at one end to a connector 38 extending from brush holder plate 26 (FIG. 2). In this way, the free end of spring member 36 is able to bias brush 34 towards central opening 28. It should also be appreciated that the brush holder plate 26 includes four leg members 42 each having a rubber cap 44 (FIG. 1). The leg members 42 enable brush holder plate 26 to be seated within housing 22 of stator 12.

A terminal 46 (FIG. 1) is provided in order to permit an electrical connection between electrical power source (not shown) and brushes 34 by means of leads 48 and 52 (FIG. 4), as well as act as a media for holding two inductors 49. Accordingly, it should be appreciated that the current from the electrical power source is then able to be supplied to brushes 34, whereupon such current is transferred to commutator 20. The current received by commutator 20 then acts upon the windings of armature 16 so as to induce an electromagnetic field. The interaction between the electromagnetic field of armature 16 and that of the magnets 13 in stator 12 causes rotor 14 to rotate.

Armature shaft 18 is preferably engaged with a bearing 50 within end cap portion 24 of stator 12 and another bearing 51 within housing 22, whereby rotation of rotor 14 is able to provide useful work. With respect to the present application, DC motor 10 is specifically utilized as a power blower mechanism for providing an air blower for an automobile, but it should be understood that DC motor 10 could be used in any number of applications and is not limited thereto. For example, the DC motor 10 could be utilized as an engine cooling fan mechanism, a power lift mechanism, a windshield wiper mechanism or other useful device.

As best illustrated in FIGS. 1 and 2, the brush boxes 32 each receive the at least one brush 34. During operation, the at least two brushes 34 cooperate with the commutator during operation and are heated up to a high temperature. The high brush temperature increases the wear rate of both brushes 34 and commutator 20, and therefore reduces the life of motor 10.

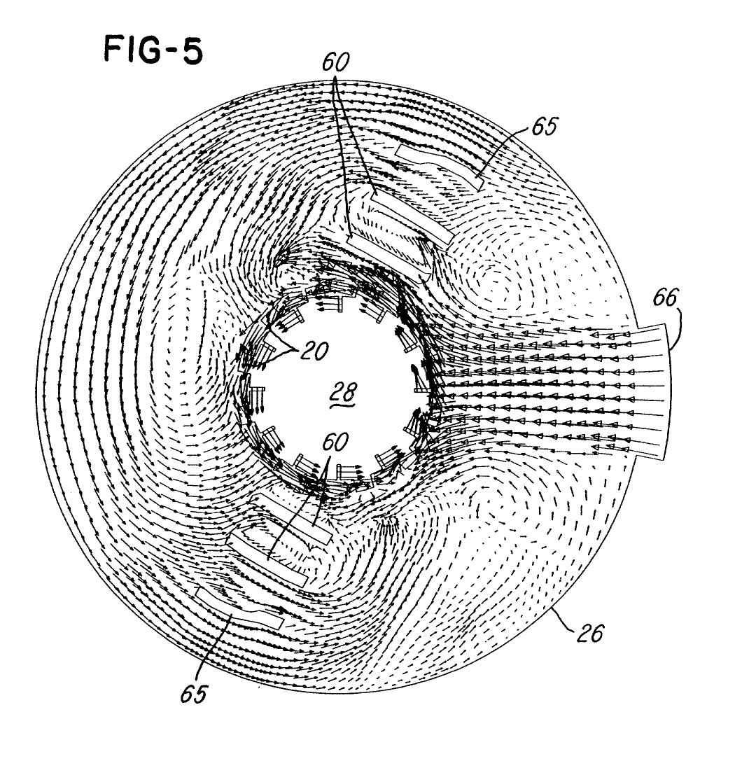

Accordingly, the invention comprises a plurality of heat sink fins 60 which are generally elongated, as best illustrated in FIGS. 2, 3 and 4. In the embodiment being described, the plurality of fins 60 are provided on a top surface 32a, but are not provided on the bottom surface 32b (FIG. 3). The plurality of fins 60 may comprise at least one contoured or curved fins 65 (FIG. 5). It should be understood, however, that the plurality of fins 60 can be provided on both top surface 32a and other surfaces 32b, 32c and 32d (FIGS. 2 and 3) and that more or fewer fins could be provided on such surfaces. Also, the plurality of fins 60 may be situated on only one of the boxes 32.

In the embodiment being described, the plurality of fins 60 are integrally formed into brush boxes 32 and both brush boxes 32 and the plurality of fins 60 are copper. To reduce the resistance of heat conduction, the thickness of the plurality of fins 60 is 1 mm. It should be understood, that brush boxes 32 and the plurality of fins 60 can also be made from other metals with high thermal conductivity, such as aluminum. Note, as illustrated in FIGS. 2 and 5, that the plurality of fins 60 are substantially parallel to each other and arranged along the streamline of the air flow around brush holder plate 26 to reduce air flow resistance and increase heat transfer coefficient of the heat sink. FIG. 5 shows a predicted velocity field around the brush holder plate 26, illustrating the direction of air flow. This predicted velocity field was obtained from a simulation that will now be described.

The simulation was performed using a Model No. BL9000 blower motor available from the Assignee of the present invention. This computational fluid dynamics and conjugate heat transfer analysis was conducted using the STAR-CD CFD package, available from CD adapco Group. Three fins were added to the brush box 32 in the manner illustrated in FIGS. 2-4. An operating point of the motor 10 was 303.8 watts input power, 72.5% efficiency, 3423 RPM, 0 and 3 cubic feet per minute (cfm) ventilation flow rate and 20 degrees Celsius ambient temperatures. The results are listed in Table I below:

TABLE I
Simulation Results

| | | Heat Sink | | Heat Sink |
|---|---|---|---|---|
| | Copper | Copper | Copper | Copper |
| | Brush Box | Brush Box | Brush Box | Brush Box |
| | (no fins) | (with fins 60) | (no fins) | (with fins 60) |
| Brush | 143-151 | 121-135 | 114-130 | 89-102 |
| Temperature | | | | |
| (Degree | | | | |
| Celsius) | | | | |
| Vent Flow | 0 CFM | 0 CFM | 3 CFM | 3 CFM |
| Rate | | | | |
| Case File | b19a/01 | b19d/01 | b19b | b19f |

Thus, the simulation shows that there is more than twenty degree centigrade temperature reduction on the brushes 34. To further substantiate this idea, an experimental study was conducted and those test results will now be described.

The tests were conducted using the Model No. BL9000 motor/GMT-800 module available from the Assignee of the present invention. The system was operating at 14 volts and by adjusting the opening on the air flow outlet, the current was set at about 22 amps. The modified brush holder box 34 is similar to the one illustrated in FIG. 2. The copper fins 60 were soldered onto the copper brush box 32, but it should be appreciated that they could be integrally formed, separately mounted or otherwise associated with the brush box 32 with a good thermal connection in order to dissipate heat as described herein. In the test module, the vent flow inlet 66 was located very close to one of the brush boxes 32 (FIG. 1). In order to facilitate reducing blockage of vent air flow into the motor, the plurality of fins 60 were added to only one side of the brush box 32 which is located away from vent inlet 66. The following Table II summarizes the test results:

TABLE II
Test Results

TEMPERATURE
(DEGREES CELSIUS)

| | Test A | Test B |
|---|---|---|
| #1 Brush | 83.5 | 73 |
| #2 Brush | 82 | 78 |
| Motor casing | 36.6 | 33.8 |
| Ambient Temperature | 21.1 | 20.3 |
| Voltage (volt) | 13.99 | 14.00 |
| Current (amps) | 22.4 | 22.4 |

In Test A, brush boxes were made of copper without fins. Test B was a repeat run of Test A, except that there were heat sink fins 60 on the brush box of #1 brush. Thus, when the copper brush box #1 was combined with the heat sink fins 60, the #1 brush temperature decreased by 9.7 degrees Celsius after the change in the ambient temperature T_{∞} is deducted. It should be appreciated that the temperature reduction margin is less than that predicted by the numerical simulations illustrated relative to Table I above. The major reason is that the surface contact between the brushes 34 and the brush box 32 is relatively poor, but at least good enough to achieve the temperature reduction mentioned in Table II. This inefficiency in heat transfer is a result of the brushes 34 having to be able to move freely inside the brush boxes 32 to insure good electrical contact between the brushes 34 and the commutator 20. Therefore, only a very small percentage of a surface of the brush 34 is actually in contact with the brush box 32 and the normal pressure in this contact area is very low. Consequently, very poor thermal connection between the brushes 34 and brush box 32 is resulted, and typically, there is a fifteen degree Celsius temperature difference between them.

Advantageously, this system provides means for reducing a brush temperature by 9.7 degrees Celsius in the embodiment being described.

In the embodiment being described, a method for decreasing brush temperature of an electric motor comprises the steps of providing a motor 10 having the aforementioned characteristics, providing the rotor 14 mounted on an armature shaft 18 and comprising the commutator 20. The method also contemplates providing the brush holder plate 26 having the aforementioned brush boxes 32 each capable of receiving at least one brush 34. The method further facilitates providing heat sink fins 60 on the brush boxes 32 for dissipating heat generated by the brushes 34.

As mentioned earlier herein, at least one or a plurality of fins 60 may be situated on one or more of the brush box 32 to achieve the desired heat dissipation characteristics.

While the methods herein described, and the forms of apparatus for carrying these methods into effect, constitute preferred embodiments of this invention, it is to be understood that the invention is not limited to these precise methods and forms of apparatus, and that changes may be made without departing from the scope of the invention, which is defined in the appended claims.

What is claimed is:

1. An electric motor or alternator comprising:
a stator comprising pairs of magnets or coils for providing an electromagnetic field;
a rotor mounted on an armature shaft and rotatably positioned in said stator, said rotor comprising a commutator positioned on an armature shaft;
a brush holder plate positioned around said commutator and comprising a plurality of brush boxes each capable of receiving at least one brush; and
said brush box comprising a heat sink for dissipating heat generated by said brushes to lower a brush temperature.

2. The electric motor or alternator as recited in claim 1 wherein said heat sink comprises at least one fin situated on said brush box.

3. The electric motor or alternator as recited in claim 1 wherein said heat sink comprises a plurality of fins situated on at least one of said plurality of brush boxes.

4. The electric motor or alternator as recited in claim 3 wherein said plurality of fins comprises at least two fins.

5. The electric motor or alternator as recited in claim 4 wherein said plurality of brush boxes comprise a plurality of fins integrally formed, separately mounted or otherwise associated with said brush box with a good thermal connection.

6. The electric motor or alternator as recited in claim 5 wherein said plurality of brush boxes and said heat sink is copper, aluminum or other materials with high thermal conductivity.

7. The electric motor or alternator as recited in claim 4 wherein said at least two fins are generally parallel to each other.

8. The electric motor or alternator as recited in claim 4 wherein at least one of said at least two fins are non-planar.

9. A method for decreasing brush temperature of an electric motor or alternator comprising the steps of:
providing a motor or alternator having a housing comprising a stator comprising at least two magnets or coils for providing an electromagnetic field;
providing a rotor mounted on an armature shaft, said rotor comprising a commutator positioned on an armature shaft;
providing a brush holder plate having a plurality of brush boxes each capable of receiving at least one brush; and
providing a heat sink on said brush box for dissipating heat generated by said brush.

10. The method as recited in claim 9 wherein said method comprises the step of:
situating at least one fin on at least one of said plurality of brush boxes to provide said heat sink.

11. The method as recited in claim 9 wherein said method comprises the step of:
situating a plurality of fins on at least one of said plurality of brush boxes to provide said heat sink.

12. The method as recited in claim 11 wherein said plurality of fins comprises at least two fins.

13. The method as recited in claim 9 wherein said method further comprises the step of:
providing a plurality of brush boxes comprising a plurality of fins integrally formed in, separately mounted or otherwise associated with said brush box with a good thermal connection.

14. The method as recited in claim 13 wherein method further comprises the step of:
integrally forming, separately mounted or otherwise associated with said plurality of brush boxes and said heat sink from copper, aluminum or other materials with high thermal conductivity.

15. The method as recited in claim 12 wherein said at least two fins are substantially parallel to each other.

16. The method as recited in claim 12 wherein at least one of said at least two fins are non-planar.

17. A brush retainer comprising:
a brush holder plate having an aperture therethrough for receiving a commutator, said brush holder further comprising a plurality of brush boxes each having at least one brush therein for contacting said commutator when said commutator is positioned in said aperture; and said brush holder comprising a heat sink.

18. The brush retainer as recited in claim 17 wherein said heat sink comprises at least one fin situated directly on said brush holder.

19. The brush retainer as recited in claim 17 wherein said heat sink comprises a plurality of fins situated directly on at least one of said plurality of brush boxes.

20. The brush retainer as recited in claim 19 wherein said plurality of fins comprises at least two fins.

21. The brush retainer as recited in claim 19 wherein said plurality of brush boxes comprise a plurality of fins integrally formed, separately mounted or otherwise associated with said brush box with a good thermal connection.

22. The brush retainer as recited in claim 17 wherein said plurality of fins are substantially parallel to one another.

23. The brush retainer as recited in claim 22 wherein said plurality of fins are copper, aluminum or other materials with high thermal conductivity.

24. The brush retainer as recite in claim 17 wherein said brushes comprise a brush temperature without said heat sink and a second brush temperature with said heat sink, said second brush temperature being at least 9.7 degrees Celsius lower than said brush temperature.

25. The brush retainer as recited in claim 20 wherein at least one of said at least two fins are non-planar.
